(19) United States
(12) Patent Application Publication
(10) Pub. No.: US 2014/0297234 A1
(43) Pub. Date: Oct. 2, 2014

(54) Forecasting production output of computing system fabrication test using dynamic predictive model

(71) Applicant: INTERNATIONAL BUSINESS MACHINES CORPORATION, Armonk, NY (US)

(72) Inventors: Juan Garzon, Staatsburgh, NY (US); Alex R. Jorge-Ortiz, Wallkill, NY (US); Gerald G. Stanquist, Salt Point, NY (US); Brian W. Stocker, Port Ewen, NY (US)

(73) Assignee: International Business Machines Corporation, Armonk, NY (US)

(21) Appl. No.: 13/853,883

(22) Filed: Mar. 29, 2013

(51) Int. Cl. G06F 17/50

(52) U.S. Cl. CPC G06F 17/5009
USPC 703/2; 703/21

(57) ABSTRACT

A dynamic predictive model of a computing system fabrication test is constructed. The computing system fabrication test is conducted over test sectors. Each test sector corresponds to a different type of the computing system fabrication test, and includes test operations that are individually performed to effectuate the test sector. The dynamic predictive model generates a predicted completion time of each test operation of each test sector. Production output of the computing system fabrication test is forecast for a scenario corresponding to a particular computing system to undergo fabrication testing, by applying the dynamic predictive model to the scenario. The production output is forecast in that a total time remaining until the particular computing system to which the scenario corresponds has completed the fabrication testing is predicted.

### BACKGROUND

Server computing devices have become the lifeblood of many organizations. For large organizations like business enterprises and governmental concerns, servers can be quite sophisticated and large pieces of hardware, involving many different components assembled in a dizzying number of particular configurations. As computing needs have grown, such organizations have purchased more and more servers, both to replace outdated existing servers and supplement existing servers with increased capacity.

### SUMMARY

An example method includes constructing, by a computing device, a dynamic predictive model of a computing system fabrication test. The computing system fabrication test is conducted over test sectors that correspond to a different type of the computing system fabrication test. Each test sector includes test operations that are individually performed to effectuate the test sector in question. The method includes forecasting production output of the computing system fabrication test for a scenario corresponding to a particular computing system to undergo fabrication testing, by the computing device, by applying the dynamic predictive model to the scenario. The dynamic predictive model generates a predicted completion time of each test operation of each test sector. The production output is forecast in that a total time remaining until the particular computing system to which the scenario corresponds has completed the fabrication testing is predicted.

An example computer program product includes a computer-readable storage medium having computer-readable code embodied therein, executable by a computing device, to construct a dynamic predictive model of a computing system fabrication test. The computing system fabrication test is conducted over test sectors that each correspond to a different type of the computing system fabrication test. Each test sector includes test operations that are individually performed to effectuate the test sector. The dynamic predicted model is constructed by performing the following for each test operation of each test sector, as a given test operation. A database is queried to determine each of an error-free run time, a fail time, an other time, and an idle time for each of a number of runs of the given test operation that have already been completed. A statistical calculation is determined of each of the error-free run time, the fail time, the other time, and the idle time for the given test operation based on the runs of the given test operation. The dynamic predicted model is further constructed determining for each test sector, as a given test sector, a predicted completion time of the given test sector based on the predicted completion times of the test operations of the given test sector.

An example system includes a modeling and forecasting computing device to construct a dynamic predictive model of a computing system fabrication test. The computing system fabrication test is conducted over test sectors that each correspond to a different type of the computing system fabrication test. Each test sector includes test operations that are individually performed to effectuate the test sector. The modeling and forecasting computing device is further to forecast production output of the computing system fabrication test for a scenario corresponding to a particular computing system to undergo fabrication testing, by applying the dynamic predictive model to the scenario. The example system includes data collection computing devices corresponding to the test sectors and that each data collect data for runs of the test operations of a corresponding test sector. The example system includes a storage device to store a database in which the data collection computing devices store the data and that is queried by the modeling and forecasting computing device to construct the dynamic predictive model.

### BRIEF DESCRIPTION OF THE SEVERAL VIEWS OF THE DRAWINGS

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1 is a diagram of an example computing system fabrication test environment.

FIG. 2 is a diagram of an example architecture for forecasting production output of a computing system fabrication test using a dynamic predictive model.

FIG. 3 is a flowchart of an example method for forecasting production output of a computing system fabrication test using a dynamic predictive model.

FIG. 4 is a flowchart of an example method for collecting data regarding fabrication test runs within the method of FIG. 3.

FIG. 5 is a flowchart of an example method for constructing a dynamic predictive model within the method of FIG. 3.

FIG. 6 is a flowchart of an example method for determining a production output forecast within the method of FIG. 5.

FIG. 7 is a diagram of an example system for forecasting production output of a computing system fabrication test using a dynamic predictive model.

### DETAILED DESCRIPTION

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure.

As noted in the background section, organizations employ sophisticated server computing devices. Such servers are generally not purchased “off the shelf,” but rather are the subject of contracts with manufacturers who can customize servers to the organizations' needs and specifications in a bespoke manner. Server manufacture many times is performed under tight schedules, to meet both customer demands as well as internal manufacturer metrics.

Such high-end server manufacture can require lengthy and complex testing processes to be performed to ensure that the servers delivered to organizations will operate correctly and without failure. These testing processes are frequently divided into two types of tests: a fabrication test corresponding to a build-to-plan phase and a fulfillment test corresponding to a build-to-order phase. In the former phase, parts that will be employed to satisfy individual customer orders are tested, on a per-part basis, on an assembly-of-parts basis, and on an anticipated-usage basis. The former phase can be performed before an actual order has arrived for fulfillment. In the latter phase, these previously tested parts and assemblies thereof are then used to build an actually ordered server per the order's specifications, and the resulting server tested.

Manufacturers have a finite amount of resources that can be dedicated to building servers in any given period of time. Given the tight schedules in which servers may have to be built in satisfaction of customer contracts, as well as internal manufacturer metrics, it is desirable to be able to forecast the production output of a computing system such as a server. For instance, it is desirable to be able to forecast the production output of a computing system undergoing the build-to-plan phase, in relation to the fabrication test corresponding to this phase of system manufacture. Being able to get a sense for when a fabrication test is likely to be completed gives manufacturer management and operating personnel a better mechanism by which the build-to-plan phase can be completed for a particular system.

Disclosed herein are techniques for forecasting production output of a computing system fabrication test using a dynamic predictive model. A dynamic predictive model for such a test is constructed, and the production output of the test is forecast for a scenario corresponding to a particular computing system to undergo fabrication testing, both before and during such testing, by applying the model to the scenario. The dynamic predictive model generates the predicted completion time of operations of test sectors over which the computing system fabrication test is conducted. The production output is thus forecast in that the total time remaining until the particular computing system to which the scenario corresponds has completed fabrication testing is predicted, before and during such testing.

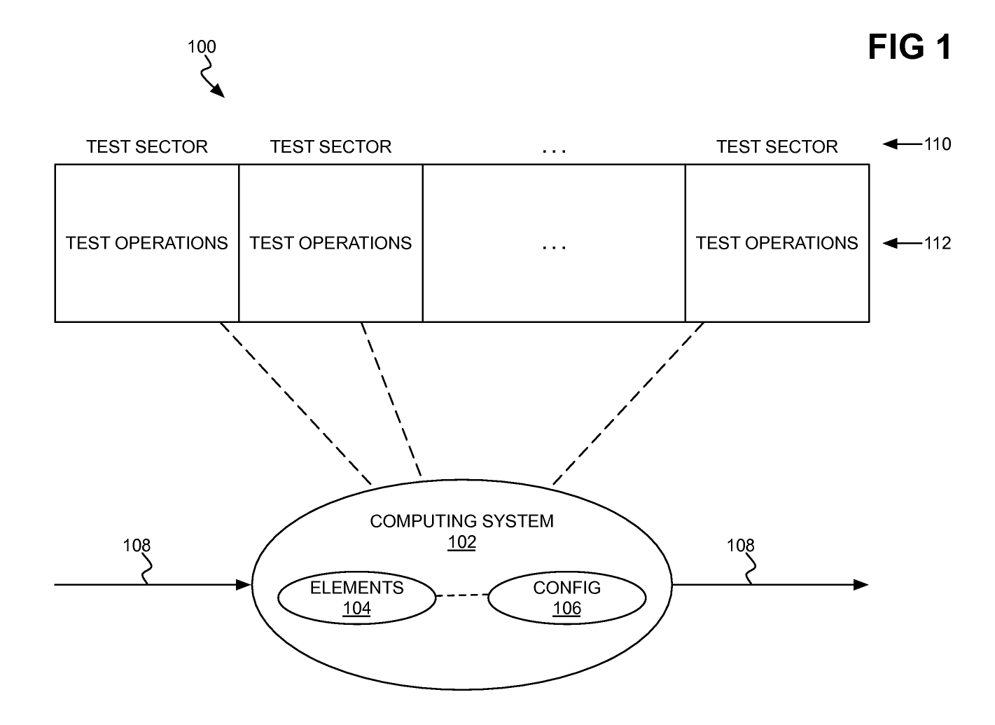

FIG. 1 shows an overview of an example computing system fabrication test environment 100. A computing system 102 undergoes the fabrication test. The system 102 includes a number of hardware elements 104 that are organized and assembled in a particular configuration 106. Examples of hardware elements 104 include processors, processor sub-assemblies, storage devices, storage device sub-assemblies, memory, memory sub-assemblies, and so on. Once the elements 104 and the configuration 106 of the system 102 have completed the fabrication test, the system 102 may be disassembled for the elements 104 to be later used in a build-to-order phase. That is, the computing system fabrication test corresponds to a build-to-plan phase.

As indicated by the arrows 108, the computing system 102 undergoes fabrication testing over a number of test sectors 110. Each test sector 110 corresponds to a different type of fabrication test that the computing system 102 is to be subjected, in a particular order. For instance, processors may first be tested individually in one test sector 110. The processors may then be installed within sub-assemblies, subjected to a nominal temperature in another test sector 110, and then subjected to a bias temperature in a third test sector 110. Once testing has been completed, the processors may be removed from the sub-assemblies and tagged appropriately for subsequent inclusion in an actual server in accordance with a build-to-order phase.

Each test sector 110 includes or encompasses a number of test operations 112. The test operations 112 are individually performed, in a particular order, on the computing system 102 to effectuate their corresponding test sectors 110. Whereas a test sector 110 indicates the type of testing to be performed, for instance, the test operations 112 making up the test sector 110 are the actions that are actually performed to effectuate the type of testing to which the test sector 110 corresponds.

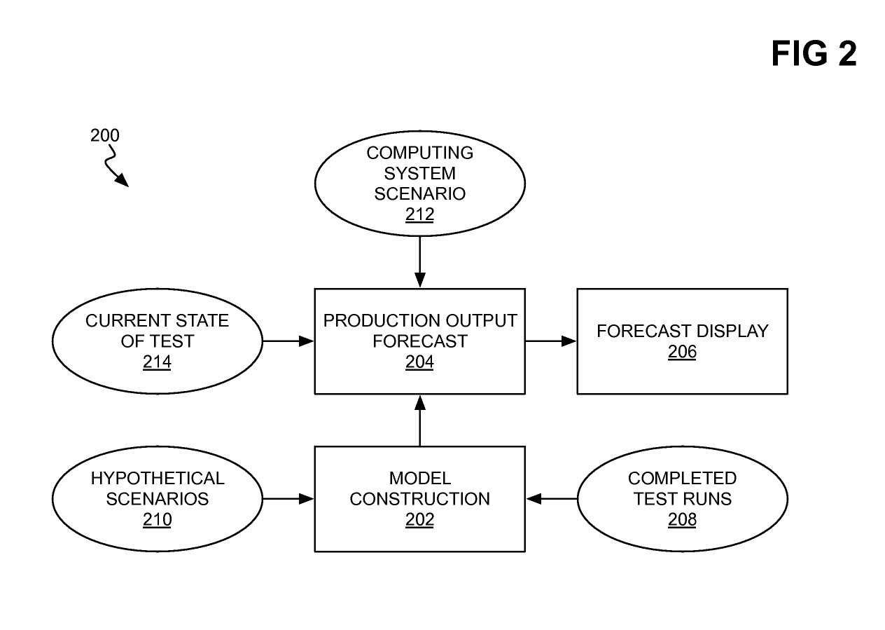

FIG. 2 shows an overview of an example architecture 200 for forecasting production output of a computing system fabrication test using a dynamic predictive model. Rectangles in FIG. 2 correspond to functionality performed in the architecture 200, whereas ovals correspond to data input within the architecture 200. Arrows represent dataflow within the architecture 200. In general, the dynamic predictive model is constructed, per block 202, and is used to forecast production output, per block 204, which is then displayed, per block 206.

The dynamic predictive model of a computing system fabrication test is constructed (202) at least based on completed runs of the test (208). That is, the model generates a predicted completion time of each test operation 112 of each test sector 110, based on previous completion times of the test operations 112 of the test sectors 110. The dynamic predictive model further can be constructed based on hypothetical scenarios (210). For instance, the completed runs of the test can be modified so that the dynamic predictive model can predict completion time if no failure occurred, if no idling occurred during testing, and so on.

The production output of the computing system fabrication test is forecast (204) for a scenario corresponding to a particular computing system 102 that is to undergo or that is undergoing fabrication testing (212). In general, the scenario includes identification of the elements 104 and the configuration 106 thereof that will be or that is currently being fabrication tested. The production output is forecast in that the total time remaining until the computing system 102 to which the scenario corresponds has completed the fabrication testing is predicted. As the system 102 completes testing, as indicated by the current state of the fabrication test (214), the forecast is thus updated.

As such, the production output forecast is displayed to a user (206). An updated, real-time indication of the total time remaining until the computing system 102 has completed the fabrication testing, as forecast, may be displayed. Similarly, the forecast completion time of each test sector and of each test operation of each test sector may be displayed as well.

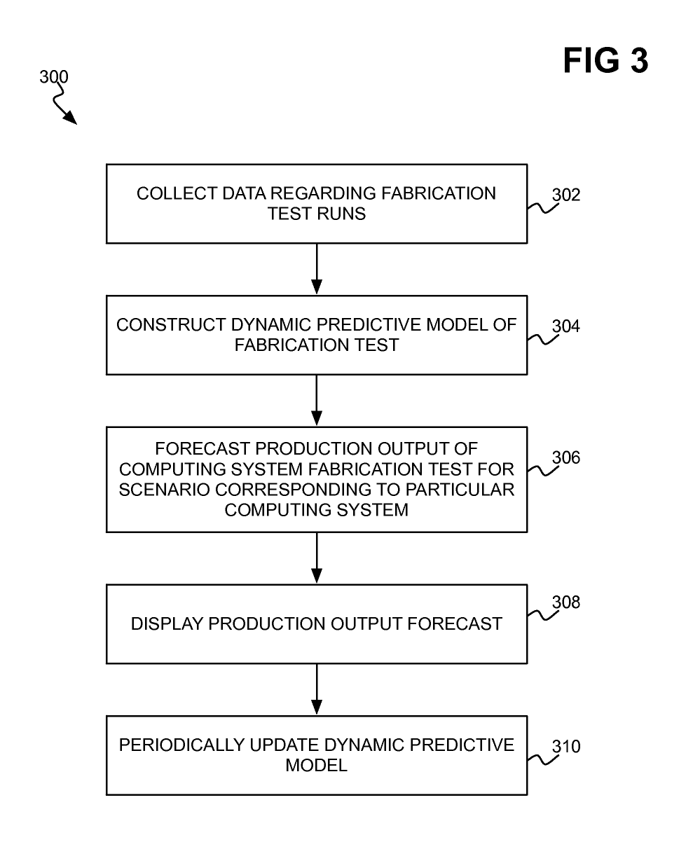

FIG. 3 shows the example architecture 200 in the form of an example method 300. The method 300 is thus for forecasting production output of a computing system fabrication test using a dynamic predictive model. As a fabrication test runs are conducted, data regarding them is collected (302). A dynamic predictive model of the fabrication test is then constructed (304), and used to forecast production output of the test for a scenario corresponding to a particular computing system (306). The results of this production output forecast are displayed (308), including updating the forecast in real-time as the test is run.

The dynamic predictive model can be periodically updated (310), by repeating the method 300 at part 304. That is, as additional runs of the computing system fabrication test have been completed, additional data is collected in part 302, such that the model can be effectively reconstructed or updated in part 304. It is at least in this respect that the predictive model is considered dynamic. As such, for instance, effects of a new personnel schedule, of new parts, and of new test equipment, will ultimately be reflected in the model as additional fabrication test runs are completed.

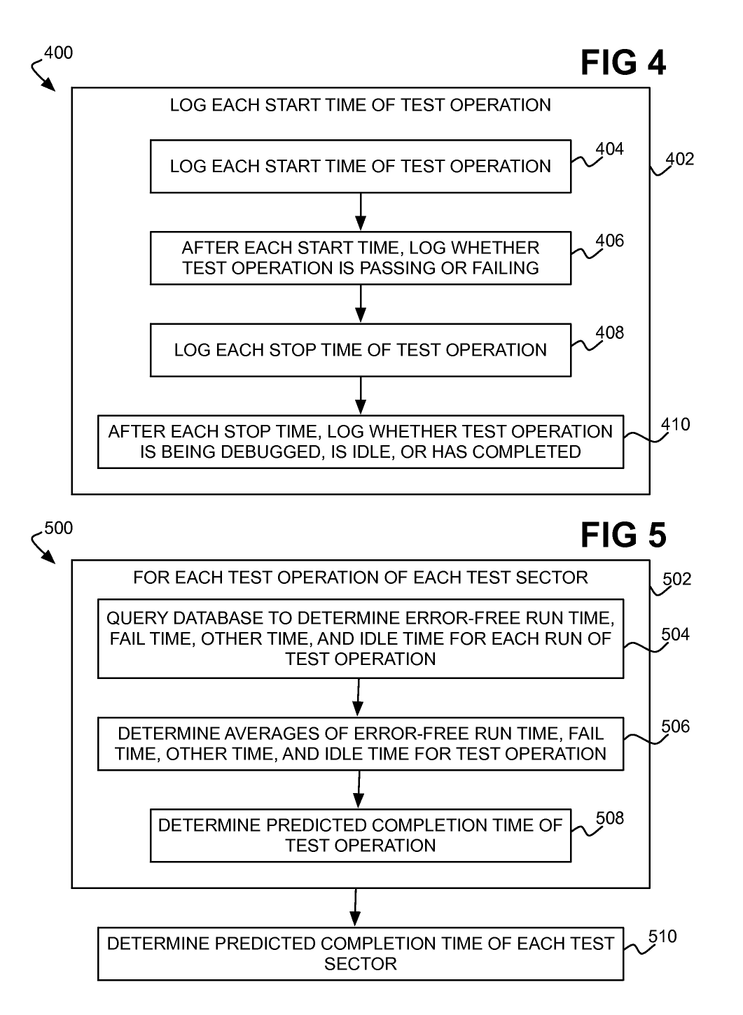

FIG. 4 shows an example method 400 for collecting data regarding fabrication test runs. The method 400 may be performed to implement part 302 of the method 300. The method 400 is specifically performed each time a fabrication test run is performed. As noted above, a fabrication test run encompasses a number of test sectors that each include a number of test operations.

During a test operation, the test operation is started at least once, at the beginning of the operation, and is stopped at least once, at the end of the operation. If the test operation does not require manual attention from a human operator, and does not fail during performance, the test operation continues unabated from start to finish. The resulting time is the best-case scenario, in which the test operation has passed without interruption. This time is referred to as the error-free run time.

However, while the test operation is being performed, it may be started and stopped multiple times. The test operation, even if passing, may stop and require manual attention from a human operator before the operation can continue. This time is referred to as idle time. If there is no human operator available to promptly attend to the test operation, the idle time can become quite long. For instance, if a test operation stops and enters idle time over a weekend, no human operator may be available until the following Monday.

If while the test operation is running a failure is detected, the test operation may stop execution and have to be debugged. Fail time thus encompasses the length of time the test operation is running while failing, as opposed to passing. When the test operation is subsequently stopped, a human operator may then have to debug the test operation to locate the cause of the failure. This time is encompassed under what is referred to as other time, which also includes any other time besides the test operation running (regardless of whether passing or failing) and idle time.

Therefore, for each test operation of each test sector of each run of the fabrication test, the following data is collected (402). Each time a test operation is started, a corresponding start time is logged within a database (404). As noted above, a test operation is started at least once, at the beginning of its performance, and thereafter may be started again if the operation is stopped for any reason. After each start time is logged, whether the test operation is currently passing or failing is also logged within the database (406). Therefore, when the test operation is running, whether this run time is passing or failing run time can be accordingly tracked.

Each time a test operation is stopped, a corresponding stop time is similarly logged within the database (408). As noted above, a test operation is stopped at least once, at completion, but may be stopped prior to completion for a number of different reasons, such as to debug a failure of the operation, to alert a human operator to manual attention being required, and so on. After each stop time is logged, whether the test operation is being debugged (i.e., due to a failure), is idle (i.e., requiring human operator attention for a non-failing reason), or has completed is also logged within the database (410).

The method 400 thus tracks the start and stop times of a test operation in parts 404 and 408, tracks whether run time corresponds to passing or failure of the operation in part 406, and tracks whether non-run time corresponds to debugging, idling, or completion of the operation in part 410. As such, error-free run time, fail time, other time, and idle time for the test operation can be determined. For instance, by subtracting the start time from the immediately subsequent stop time yields a length of time that can be classified as one of these four types of time.

FIG. 5 shows an example method 500 for constructing a dynamic predictive model of a fabrication test. The method 500 may be performed to implement part 304 of the method 300. The method 500 can be periodically re-performed, as part 310 of the method 300, to update the predictive model, based on additional data that has been collected as a result of the method 400 having been performed, for instance.

A fabrication test encompasses a number of test sectors that each include a number of test operations, as noted above. For each test operation of each test sector of the fabrication test, the following is performed (502). The database is queried so that the error-free run time, the fail time, the other time, and the idle time for each run of the test operation in question that has been logged in the database can be determined (504), as noted above.

The error-free run time is the best-case time to complete the test operation when the test operation is run from start to completion without failure or interrupt, as noted above. The fail time is the time in which the test operation is running but is failing. The other time is the time in which the test operation is running and includes activity being performed to move the test operation to an active state, such as debugging. The idle time is the time in which the test operation is not running and no activity is being performed to move the test operation to an active state, such as when operator attention is required for the operation to resume.

Based on querying of the database and the error-free run time, the fail time, the other time, and the idle time that have been determined for each run of the test operation, averages of these four times are determined for the test operation (506). As such, an average error-free run time, an average fail time, an average other time, and an average idle time are each determined. Averaging is a type of statistical calculation, and other types of statistical calculation can alternatively or additionally be performed. As one example, the median times for the test operation may be calculated in addition to or in lieu of the average times.

A predicted completion time of the test operation is then determined based on the averages, and/or other statistical calculations, of the error-free run time, the fail time, the other time, and the idle time (508). The predicted completion time of a test operation is thus what the dynamic predictive model yields for the test operation in question. The predicted completion time is the length of time it will likely take to complete the test operation. This time is determined in one implementation by simply adding the averages of error-free run time, fail time, other time, and idle time, but in other implementations, more sophisticated techniques can be employed to determine the predicted completion time based on these or other statistical calculation results.

For each test sector, the method 500 also includes determining the predicted completion time thereof (510). The predicted completion time of a test sector is in one implementation equal to the sum of the predicted completion times of the test operations that make up the test sector in question. The predicted completion time of a test sector is thus what the dynamic predictive model yields for the test sector in question. Because a fabrication test encompasses a number of test sectors, the predicted completion time of the fabrication test as a whole can therefore be the sum of the predicted completion times of these test sectors.

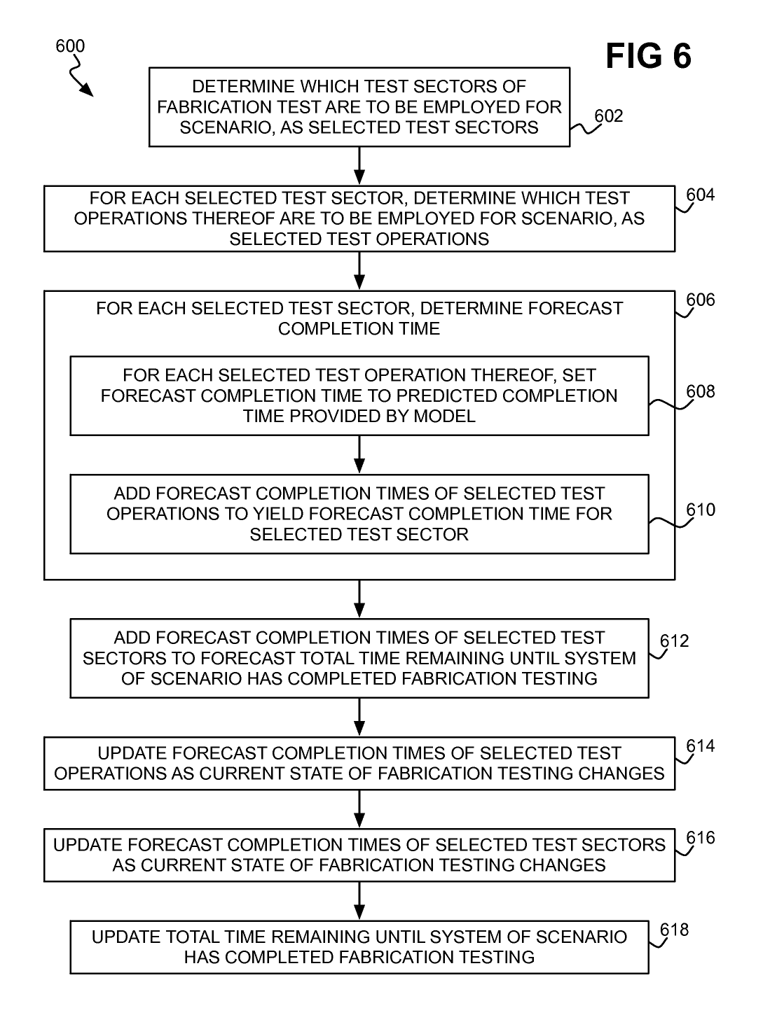

FIG. 6 shows an example method 600 for forecasting production output of a fabrication test for a specific scenario corresponding to a particular computing system (600). The method 600 may be performed to implement part 306 of the method 300. As noted above, a fabrication test in generally includes a number of test sectors that each include a number of test operations. However, for a particular computing system that is to undergo fabrication testing, not all the test sectors and not all the test operations of all the test sectors may have to be performed.

This at least in part depends on the elements, such as the hardware elements, of the computing system. For instance, if a given computing system does not have a certain type of memory, then test operations and/or test sectors pertaining to this type of memory do not have to be performed. As another example, if a particular computing system does not have its processors in a certain type of configuration, then test operations and/or test sectors pertaining to this type of configuration similarly do not have to be performed.

Therefore, which test sectors of the fabrication test have to be employed (i.e., performed), at least in part, for the scenario in question are determined (602). For instance, each test sector may specify the type of hardware element(s) or configuration(s) to which it is applicable. This specification can be compared to the elements and configuration of the particular computing system to determine whether the test sector is relevant to the scenario in question. These test sectors are referred to herein as selected test sectors, and include one or more of the test sectors of the fabrication test.

For each selected test sector, which test operations thereof are to be employed for the scenario in question are likewise determined (604). For instance, as with a test sector generally, each test operation thereof may specify the type of hardware element(s) or configuration(s) to which it is applicable. This specification can be compared to the elements and configuration of the particular computing system to determine whether the test operation is relevant to the scenario in question. These test operations are referred to herein as selected test operations, and include one or more of the test operations of the selected test sectors of the fabrication test.

For each selected test sector, a forecast completion time is determined using the dynamic predictive model (606). The forecast completion time of a selected test sector is the length of time remaining to complete the selected test operations of the selected test sector in relation to the particular computing system of the scenario for which the method 600 is being performed. In one implementation, part 606 is effectuated by performing the following for each selected test sector.

For each selected test operation of a selected test sector, a forecast completion time is set to the predicted completion time for the selected test operation provided by the dynamic predictive model (608). The forecast completion time of a selected test operation is the length of time remaining to complete the selected test operation of the selected test sector in relation to the particular computing system of the scenario for which the method 600 is being performed. The forecast completion times of all the selected test operations of a selected test sector are thus added together to yield the forecast completion time for this selected test sector (610). The forecast completion times of all the selected test sectors are then added together to forecast the total time remaining until the particular computing system of the scenario has completed fabrication testing (612).

The above parts of the method 600 are performed prior to the particular computing system actually undergoing fabrication testing. As fabrication testing occurs, the current state of the fabrication test changes. The current state of the fabrication test evolves as selected test operations of selected test sectors are completed in actuality, and as selected test sectors are completed in actuality. Therefore, the forecast time remaining until the particular computing system has completed fabrication testing typically becomes more accurate as the fabrication testing is completed.

The forecast completion times of the selected test operations are thus updated as the current state of the fabrication testing changes (614). For instance, the forecast completion times of selected test operations that have been completed can be replaced with their actual completion times, which means that the forecast time remaining is that much more accurate since these completion times are no longer predictive in nature, but actual. The forecast completion times of the selected test sectors are also updated as the current state changes (616), such as by replacing the forecast completion times of selected test sectors that have been completed with their actual completion times. As such, the total time remaining until the particular computing system has completed fabrication testing can be correspondingly updated based on these forecast completion times as updated in parts 614 and 616 (618).

As noted above in relation to the method 300, the production output forecast is displayed to a user. In particular, this can include displaying updated in real-time indications of the various forecast completion times and the total time remaining For instance, at a minimum, the total time remaining until the particular computing system has completed fabrication testing, as forecast, may be displayed and updated in real-time. The user may be permitted to view the selected test sectors and their forecast completion times as well, again updated in real-time. The user may also be permitted to view the selected test operations of each selected test sector and their forecast completion times, updated in real-time, too.

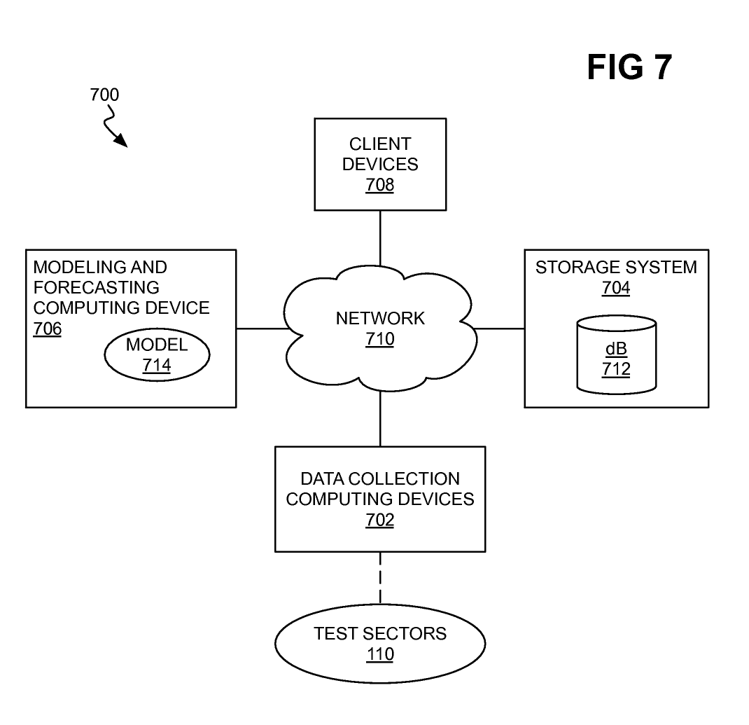

FIG. 7 shows an example system 700 by which the techniques that have been disclosed can be implemented. The system 700 includes data collection computing devices 702, a storage system 704, a modeling and forecasting computing device 706, and client devices 708. A network 710 communicatively interconnects the devices 702, 704, 706, and 708, and can be or include a local-area network (LAN), a wide-area network (WAN), a wired network, a wireless network, and so on. The system 700 can include other devices, in addition to and/or in lieu of those depicted in FIG. 7.

The data collection computing devices 702 are disposed at the locations of the test sectors 110, and there may be one such computing device 702 at and for each test sector 110. The computing devices 702 monitor operation of the test operations 112 of their respective test sectors 110, and collect and log data regarding their states, start times, and stop times, as has been described. As such, the computing devices 702 can perform part 302 of the method 300 and the method 400 that have been described. The storage system 704 may be a standalone storage device or include a computing device communicatively connected to or that includes such a storage device. The storage system 704 stores a database 712 to which the data collection computing devices 702 log data.

The modeling and forecasting computing device 706 generates a dynamic predictive model 714 and applies the model to a scenario representative of a particular system undergoing fabrication test to forecast production output. The computing device 706 generates the model 714 by querying the database 712 to collect data regarding the test sectors 110 of the fabrication test, as has been described. The computing device 706 thus can perform parts 304, 306, and 310 of the method 300, as well as the methods 500 and 600 that have been described.

The client devices 708 can be the computing or other devices by which users are able to view the predicted completion times provided by the modeling and forecasting computing device 706. The client devices 708 can be or include laptop computers, desktop computers, smartphones, tablet computing devices, and so on. The client devices 708 thus perform part 308 of the method 300 that has been described.

It is noted that, as can be appreciated by one those of ordinary skill within the art, aspects of the present invention may be embodied as a system, method or computer program product. Accordingly, aspects of the embodiments of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

In general, a computer program product includes a computer-readable medium on which one or more computer programs are stored. Execution of the computer programs from the computer-readable medium by one or more processors of one or more hardware devices causes a method to be performed. For instance, the method that is to be performed may be one or more of the methods that have been described above.

The computer programs themselves include computer program code. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

We claim:

1. A method comprising:
constructing, by a computing device, a dynamic predictive model of a computing system fabrication test, the computing system fabrication test conducted over a plurality of test sectors, each test sector corresponding to a different type of the computing system fabrication test, each test sector comprising a plurality of test operations that are individually performed to effectuate the test sector; and
forecasting production output of the computing system fabrication test for a scenario corresponding to a particular computing system to undergo fabrication testing, by the computing device, by applying the dynamic predictive model to the scenario,
wherein the dynamic predictive model generates a predicted completion time of each test operation of each test sector,
and wherein the production output is forecast in that a total time remaining until the particular computing system to which the scenario corresponds has completed the fabrication testing is predicted.

2. The method of claim 1, wherein constructing the dynamic predictive model comprises, for each test sector, as a given test sector:
for each test operation of the given test sector, as a given test operation, performing:
querying a database to determine each of an error-free run time, a fail time, an other time, and an idle time for each of a plurality of runs of the given test operation that have already been completed;
determining a statistical calculation of each of the error-free run time, the fail time, the other time, and the idle time for the given test operation based on the runs of the given test operation; and
determining the predicted completion time of the given test operation based on the statistical calculation each of the error-free run time, the fail time, the other time, and the idle time for the given test operation.

3. The method of claim 2, wherein constructing the dynamic predictive model further comprises, for each test sector, as the given test sector:
determining a predicted completion time of the given test sector based on the predicted completion times of the test operations of the given test sector.

4. The method of claim 2, wherein the statistical calculation is an averaging calculation.

5. The method of claim 2, wherein the error-free run time is a best-case time to complete the given test operation when the given test operation is run from start to completion without any failure and without any interruption,
wherein the fail time is a time in which the given test operation is running but is failing,
wherein the other time is a time in which the given test operation is not running and activity is being performed to move the given test operation to an active state,
and wherein the idle time is a time in which the given test operation is not running and no activity is being performed to move the given test operation to the active state.

6. The method of claim 2, wherein forecasting the production output comprises:
determining, as a plurality of selected test sectors, which of the test sectors are to be employed for the scenario, based on specifics of the particular computing system to which the scenario corresponds;
for each selected test sector, as a given test sector, determining, as a plurality of selected test operations, which of the test operations of the given test sector are to be employed for the scenario, based on the specifics of the particular computing system to which the scenario corresponds;
for each selected test sector, as a given selected test sector, performing:
for each selected test operation of the given selected test sector, as a given selected test operation, setting a forecast completion time of the given selected test operation to the predicted completion time of the given selected test operation provided by the dynamic predictive model;
adding the forecast completion times of the selected test operations of the given selected test sector to yield a forecast completion time of the given selected test sector; and
adding the forecast completion times of the selected test sectors to forecast the total time remaining until the particular computing system to which the scenario corresponds has completed the fabrication testing.

7. The method of claim 6, wherein forecasting the production output further comprises, upon the particular computing system to which the scenario corresponds undergoes the fabrication testing:
updating the forecast completion times of the selected test operations of the selected test sectors as a current state of the fabrication testing changes, including:
replacing the forecast completion times of the selected test operations of the selected test sectors as the selected test operations are completed with actual completion times of the selected test operations of the selected test sectors;
updating the forecast completion times of the selected test sectors as the current state of the fabrication testing changes, including:
replacing the forecast completion times of the selected test sectors as the selected test sectors are completed with actual completion times; and
updating the total time remaining until the particular computing system to which the scenario corresponds has completed the fabrication testing as the current state of the fabrication testing changes, based on the forecast completion times of the selected test operations and of the selected test sectors as have been updated.

8. The method of claim 6, wherein the specifics of the particular computing system comprise a plurality of hardware elements of the particular computing system and a configuration of the hardware elements.

9. The method of claim 6, further comprising:
displaying, by the computing device, updated in real-time indications of:
the total time remaining until the particular computing system has completed the fabrication testing, as forecast;
the forecast completion time of each selected test sector; and
the forecast completion time of each selected test operation of each selected test sector.

10. The method of claim 2, further comprising:
collecting, by a data collection computing device, data for the runs of the given test operation, by performing, for the given test operation:
each time of one or more times the given test operation is started, logging a start time for the given test operation within the database;
after each time of the one or times the given test operation has started, logging whether the given test operation is passing or failing;
each time of one or more times the given test operation is stopped, logging a stop time for the given test operation within the database; and
after each time of the one or more times the given test operation has stopped, logging whether the given test operation is being debugged, is idle, or has completed.

11. The method of claim 10, wherein the error-free run time encompasses the given test operation passing, the fail time encompasses the given test operation failing, the other time encompasses the given test operation being debugged, and the idle time encompasses the given test operation being idle.

12. The method of claim 2, further comprising:
periodically updating the dynamic predictive model, by the computing device, as additional runs of the given test operation have been completed and logged into the database, by repeating the method at constructing the dynamic predictive model.

13. The method of claim 2, wherein the dynamic predictive model is constructed based on the runs of the given test operation as occurred in actuality.

14. The method of claim 2, wherein the dynamic predictive model is constructed based on the runs of the given test operation as modified in accordance with a hypothetical scenario.

15. A computer program product comprising:
a computer-readable storage medium having computer-readable code embodied therein, executable by a computing device, to construct a dynamic predictive model of a computing system fabrication test, the computing system fabrication test conducted over a plurality of test sectors, each test sector corresponding to a different type of the computing system fabrication test, each test sector comprising a plurality of test operations that are individually performed to effectuate the test sector, the dynamic predicted model constructed by:
for each test operation of each test sector, as a given test operation, performing:
querying a database to determine each of an error-free run time, a fail time, an other time, and an idle time for each of a plurality of runs of the given test operation that have already been completed;
determining a statistical calculation of each of the error-free run time, the fail time, the other time, and the idle time for the given test operation based on the runs of the given test operation; and
for each test sector, as a given test sector:
determining a predicted completion time of the given test sector based on the predicted completion times of the test operations of the given test sector.

16. The computer program product of claim 15, wherein the error-free run time is a best-case time to complete the given test operation when the given test operation is run from start to completion without any failure and without any interruption,
wherein the fail time is a time in which the given test operation is running but is failing,
wherein the other time is a time in which the given test operation is not running and activity is being performed to move the given test operation to an active state,
and wherein the idle time is a time in which the given test operation is not running and no activity is being performed to move the given test operation to the active state.

17. The computer program product of claim 15, wherein the computer-readable code is further executable by the computing device to:
periodically update the dynamic predictive model, as additional runs of the given test operation have been completed and logged into the database, by repeating at constructing the dynamic predictive model.

18. The computer program product of claim 15, wherein the dynamic predictive model is constructed based on the runs of the given test operation as occurred in actuality.

19. The computer program product of claim 15, wherein the dynamic predictive model is constructed based on the runs of the given test operation as modified in accordance with a hypothetical scenario.

20. A system comprising:
a modeling and forecasting computing device to:
construct a dynamic predictive model of a computing system fabrication test, the computing system fabrication test conducted over a plurality of test sectors, each test sector corresponding to a different type of the computing system fabrication test, each test sector comprising a plurality of test operations that are individually performed to effectuate the test sector; and
forecast production output of the computing system fabrication test for a scenario corresponding to a particular computing system to undergo fabrication testing, by applying the dynamic predictive model to the scenario;
a plurality of data collection computing devices corresponding to the test sectors, each data collection computing device to collect data for a plurality of runs of the test operations of a corresponding test sector; and
a storage device to store a database in which the data collection computing devices store the data and that is queried by the modeling and forecasting computing device to construct the dynamic predictive model.
